(19) United States
(12) Patent Application Publication
(10) Pub. No.: US 2025/0246646 A1
(43) Pub. Date: Jul. 31, 2025

(54) FUEL CELL STACK

(71) Applicant: TOYOTA BOSHOKU KABUSHIKI KAISHA, Aichi-ken (JP)

(72) Inventors: Akihiro INUKAI, Okazaki-shi (JP); Harutaka ODA, Toyota-shi (JP); Satoshi KAWABE, Ichinomiya-shi (JP); Haruyuki AONO, Aichi-ken (JP); Kensuke DOI, Obu-shi (JP)

(73) Assignee: TOYOTA BOSHOKU KABUSHIKI KAISHA, Aichi-ken (JP)

(21) Appl. No.: 19/035,270

(22) Filed: Jan. 23, 2025

(30) Foreign Application Priority Data
Jan. 30, 2024 (JP) 2024-011880

(51) Int. Cl. H01M 8/0263; H01M 8/0265; H01M 8/242; H01M 8/2457

(52) U.S. Cl. CPC H01M 8/0263; H01M 8/0265; H01M 8/242; H01M 8/2457

(57) ABSTRACT

A fuel cell stack includes stacked single cells. Each single cell includes a power generating unit, a frame including an accommodating hole, and two separators. Each separator has a surface facing the power generating unit. The surface has a gas passage. The gas passage includes first extensions and a second extension. A partition rib is provided between two of the first extensions connected to each other by the second extension. The partition rib includes a base that is in contact with a corresponding one of the gas diffusion layers of the power generating unit, and a protrusion that protrudes from the base into the corresponding gas diffusion layer. The protrusion has an opposing end opposed to an inner surface of the accommodating hole. A pressure loss increasing portion is provided at a boundary between the opposing end and the inner surface of the accommodating hole.

### CROSS-REFERENCE TO RELATED APPLICATIONS

This application is based upon and claims the benefit of priority from Japanese Patent Application No. 2024-011880, filed on Jan. 30, 2024, the entire contents of which are incorporated herein by reference.

### BACKGROUND

### 1. Field

The present disclosure relates to a fuel cell stack.

### 2. Description of Related Art

Single cells of a fuel cell stack include a membrane electrode gas diffusion layer assembly and two separators that sandwich the membrane electrode gas diffusion layer assembly. The membrane electrode gas diffusion layer assembly includes a membrane electrode assembly and two gas diffusion layers that sandwich the membrane electrode assembly. The surface of each separator facing the gas diffusion layer has a gas passage through which reactant gas flows. The gas diffusion layer has pores that permit the passage of reactant gas to diffuse the reactant gas.

Japanese Laid-Open Patent Publication No. 2008-4478 discloses a fuel cell including separators, each having a serpentine gas passage that meanders. The separator includes a rib that partitions a section of the gas passage. In this section, reactant gas flows in opposite directions. The rib is fixed to the gas diffusion layer by a liquid sealing material. The liquid sealing material permeates the gas diffusion layer. Thus, the pores in the portion of the gas diffusion layer that is in contact with the rib are filled with the liquid sealing material. This suppresses path cut, a situation in which reactant gas flows between gas passages beyond the rib within the gas diffusion layer.

In the fuel cell disclosed in the above-described publication, the liquid sealing material needs to be provided between the rib of the separator and the gas diffusion layer, which may increase the number of steps in a fuel cell manufacturing process. Accordingly, it is desired to suppress the path cut of reactant gas with a relatively simple configuration.

### SUMMARY

This Summary is provided to introduce a selection of concepts in a simplified form that are further described below in the Detailed Description. This Summary is not intended to identify key characteristics or essential characteristics of the claimed subject matter, nor is it intended to be used as an aid in determining the scope of the claimed subject matter.

An aspect of the present disclosure provides a fuel cell stack that includes stacked single cells. Each of the single cells includes a power generating unit that includes a membrane electrode assembly and two gas diffusion layers. The gas diffusion layers sandwich the membrane electrode assembly. Each of the single cells also includes a frame including an accommodating hole that accommodates the power generating unit, and two separators that sandwich the power generating unit and the frame. Each of the separators of the single cell has a surface facing the power generating unit. The surface facing the power generating unit has a gas passage through which reactant gas flows. The gas passage includes first extensions which are arranged in parallel to each other and in which the reactant gas flows in opposite directions, and a second extension that connects ends of two of the first extensions arranged in parallel. A partition rib is provided between the two of the first extensions connected to each other by the second extension. The partition rib partitions the two of the first extensions from each other. The partition rib includes a base that is in contact with a corresponding one of the two gas diffusion layers of the power generating unit and extends along the first extensions, and a protrusion that protrudes from the base into the corresponding one of the two gas diffusion layers and extends along the first extensions. The protrusion has an opposing end opposed to an inner surface of the accommodating hole. A pressure loss increasing portion is provided at a boundary between the opposing end and the inner surface of the accommodating hole. The pressure loss increasing portion causing a pressure loss of the reactant gas flowing between the two of the first extensions beyond the opposing end to be higher than a pressure loss of the reactant gas flowing through the two of the first extensions.

Other features and aspects will be apparent from the following detailed description, the drawings, and the claims.

### BRIEF DESCRIPTION OF THE DRAWINGS

FIG. 1 is a cross-sectional view of a fuel cell stack according to a first embodiment.

FIG. 2 is an exploded perspective view of the single cell shown in FIG. 1.

FIG. 3 is a plan view showing the gas passage of each separator shown in FIG. 1.

FIG. 4 is an enlarged plan view showing the partition rib of the separator shown in FIG. 3.

FIG. 5 is a cross-sectional view taken along line 5-5 in FIG. 4.

FIG. 6 is a cross-sectional view taken along line 6-6 in FIG. 4.

FIG. 7 is a plan view illustrating the partition rib according to a first modification.

FIG. 8 is a plan view illustrating the partition rib according to a second modification.

FIG. 9 is a cross-sectional view illustrating the partition rib according to a third modification.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

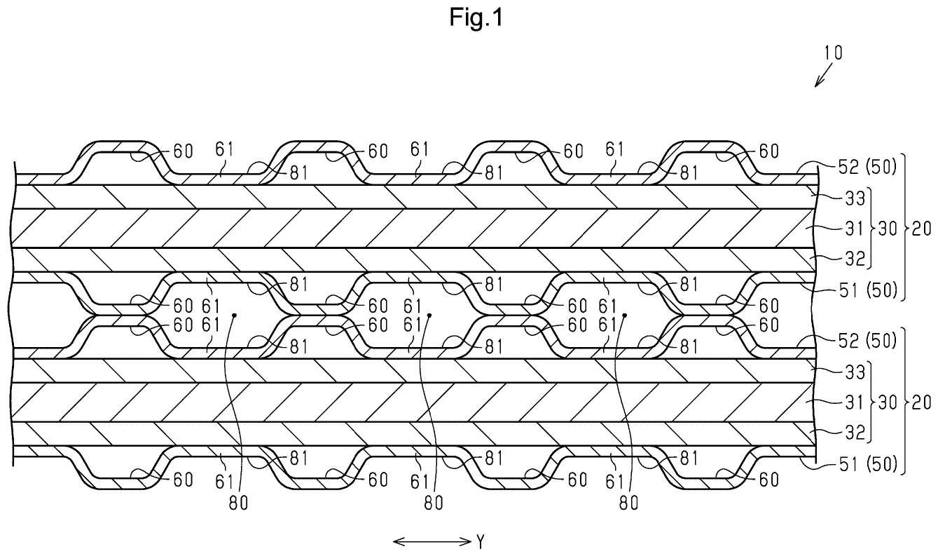

A fuel cell stack 10 according to an embodiment will now be described below with reference to FIGS. 1 to 6.

### Fuel Cell Stack 10

As shown in FIG. 1, the fuel cell stack 10 is formed by stacking single cells 20.

### Single Cell 20

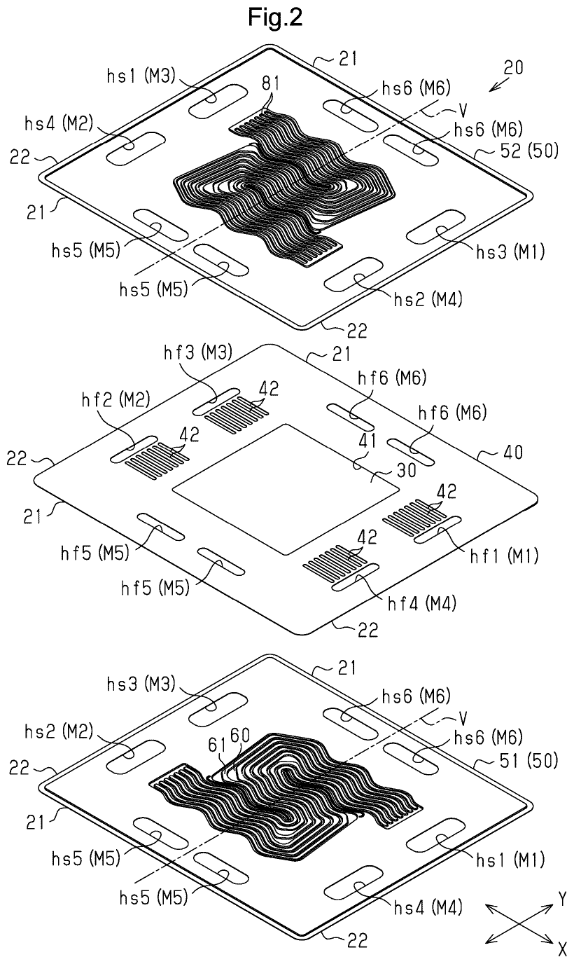

As shown in FIG. 2, the single cell 20 has the shape of, for example, a square plate. That is, the single cell 20 includes two first sides 21, which extend parallel to each other, and two second sides 22, which are orthogonal to the first sides 21 and extend parallel to each other.

In the following description, the direction in which the single cells 20 are stacked will simply be referred to as the stacking direction. The direction in which the first sides 21 extend will be referred to as the X-axis direction, and the direction in which the second sides 22 extend will be referred to as the Y-axis direction. The stacking direction, the X-axis direction, and the Y-axis direction are orthogonal to each other.

Each single cell 20 includes a fuel gas supply manifold M1, which supplies fuel gas to the single cell 20, a fuel gas discharge manifold M2, which discharges fuel gas to the outside of the single cell 20. Further, the single cell 20 includes an oxidant gas supply manifold M3, which supplies oxidant gas to the single cell 20, and an oxidant gas discharge manifold M4, which discharges oxidant gas to the outside of the single cell 20.

The manifolds M1 to M4 each have, for example, the shape of a stadium elongated in the Y-axis direction. The fuel gas supply manifold M1 and the oxidant gas discharge manifold M4 are located at the end of the single cell 20 on one side in the X-axis direction and arranged in this order from one side to the other side in the Y-axis direction. The fuel gas discharge manifold M2 and the oxidant gas supply manifold M3 are located at the end of the single cell 20 on the other side in the X-axis direction, which is opposite to the one side, and arranged in this order from the other side to the one side in the Y-axis direction. Fuel gas is, for example, hydrogen. Oxidant gas is, for example, air.

The single cell 20 includes two cooling medium supply manifolds M5, which supply cooling medium to the fuel cell stack 10, and two cooling medium discharge manifolds M6, which discharge cooling medium to the outside of the fuel cell stack 10. Each cooling medium supply manifold M5 and each cooling medium discharge manifold M6 have, for example, the shape of a stadium elongated in the X-axis direction. The two cooling medium supply manifolds M5 are located at the end of the single cell 20 on the other side in the Y-axis direction and spaced apart from each other in the X-axis direction. The two cooling medium discharge manifolds M6 are located at the end of the single cell 20 on the one side in the Y-axis direction and spaced apart from each other in the X-axis direction. Cooling medium is, for example, water.

The single cell 20 includes a power generating unit 30, a frame 40, and two separators 50. The power generating unit 30 has a sheet shape. The frame 40 surrounds the outer edge of the power generating unit 30. The two separators 50 sandwich the power generating unit 30 and the frame 40 from the opposite sides in the stacking direction. The power generating unit 30 and the separator 50 have, for example, a square shape in a plan view. The frame 40 has, for example, a square frame shape in plan view.

### Power Generating Unit 30

As shown in FIG. 1, each power generating unit 30 includes a membrane electrode assembly 31, an anode-side gas diffusion layer 32, and a cathode-side gas diffusion layer 33. The anode-side gas diffusion layer 32 and the cathode-side gas diffusion layer 33 sandwich the membrane electrode assembly 31. The anode-side gas diffusion layer 32 has pores that permit the passage of fuel gas. The cathode-side gas diffusion layer 33 has pores that permit the passage of oxidant gas.

The membrane electrode assembly 31 includes an electrolyte membrane, an anode electrode catalyst layer, and a cathode electrode catalyst layer, which are not shown in the drawings. The anode electrode catalyst layer and the cathode electrode catalyst layer sandwich the electrolyte membrane. The anode-side gas diffusion layer 32 is laminated on the anode electrode catalyst layer. The cathode-side gas diffusion layer 33 is laminated on the cathode electrode catalyst layer.

Fuel gas is supplied to the anode-side surface of the power generating unit 30 through the fuel gas supply manifold M1. Oxidant gas is supplied to the cathode-side surface of the power generating unit 30 through the oxidant gas supply manifold M3. As a result, the power generating unit 30 generates power from the electrochemical reaction between the fuel gas and the oxidant gas.

In the fuel cell stack 10, each single cell 20 generates heat during the power generation of the power generating unit 30. Thus, the fuel cell stack 10 includes cooling passages 80, which will be described later. Cooling medium is supplied to the cooling passages 80 through the cooling medium supply manifolds M5.

### Frame 40

The frame 40 is made of an insulating resin material.

The frame 40 includes an accommodating hole 41 at the middle portion of the frame 40 to accommodate the power generating unit 30. The accommodating hole 41 has a square shape, in plan view, aligned along the outer edge of the power generating unit 30.

The frame 40 includes through-holes hf1 to hf6, which respectively define manifolds M1 to M6, on the outer side of the accommodating hole 41.

The frame 40 includes slits 42 that extend through the frame 40 and are located between the accommodating hole 41 and the through-holes hf1 to hf4. The slits 42 are arranged in parallel and spaced apart from each other in the Y-axis direction. Each slit 42 has the shape of a stadium elongated in the X-axis direction. One end of each slit 42 is connected to one of through-holes hs1 to hs4 of the separator 50, which will be described later, in the stacking direction. The other end of each slit 42, which is opposite to the one end, is connected to the gas passage 60 of the separator 50, which will be described later, in the stacking direction. Each of the manifolds M1 to M4 is connected to the gas passage 60 through, for example, seven slits 42.

### Separator 50

The separator 50 is formed by pressing a metal (e.g., stainless steel, titanium alloy, or pure titanium) plate.

One of the two separators 50 is located on the anode-side surface of the power generating unit 30. The other separator 50 is located on the cathode-side surface of the power generating unit 30.

Hereinafter, the separator 50 located on the anode-side surface of the power generating unit 30 may be referred to as the anode separator 51, and the separator 50 located on the cathode-side surface of the power generating unit 30 may be referred to as the cathode separator 52.

The anode separator 51 and the cathode separator 52 have the same shape. The anode separator 51 and the cathode separator 52 are arranged in orientations that are inverted relative to each other about the hypothetical axis V, with respect to the power generating unit 30. The hypothetical axis V passes through the center of the separator 50 in the X-axis direction and extends in the Y-axis direction.

The separator 50 includes through-holes hs1 to hs6, which respectively define the manifolds M1 to M6. As described above, the anode separator 51 and the cathode separator 52 are arranged in orientations that are inverted with respect to the power generating unit 30. Thus, the through-hole hs1 of the anode separator 51 is connected to the through-hole hs3 of the cathode separator 52, and the through-hole hs2 of the anode separator 51 is connected to the through-hole hs4 of the cathode separator 52. Further, the through-hole hs3 of the anode separator 51 is connected to the through-hole hs1 of the cathode separator 52, and the through-hole hs4 of the anode separator 51 is connected to the through-hole hs2 of the cathode separator 52. Furthermore, the through-hole hs5 of the anode separator 51 is connected to the through-hole hs5 of the cathode separator 52, and the through-hole hs6 of the anode separator 51 is connected to the through-hole hs6 of the cathode separator 52.

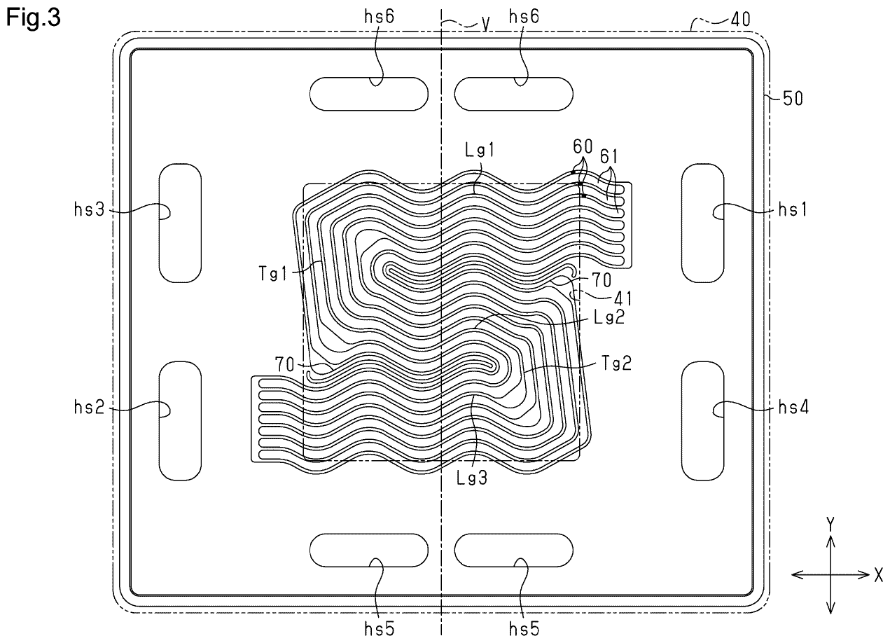

As shown in FIG. 3, groove-shaped gas passages 60 and ribs 61 are alternately arranged on the surface of the separator 50 that faces the power generating unit 30. Reactant gas flows through the gas passages 60. The ribs 61 extend along the gas passages 60. The separator 50 includes, for instance, eight gas passages 60 extending parallel to each other. Each gas passage 60 has a serpentine shape, extending in a meandering pattern from the through-hole hs1 to the through-hole hs2.

Fuel gas flows through the gas passages 60 of the anode separator 51 as reactant gas. Oxidant gas flows through the gas passages 60 of the cathode separator 52 as reactant gas. The reactant gases are supplied to the power generating unit 30 by flowing through the gas passages 60.

The reactant gases in the fuel cell stack 10 are supplied using, for example, a counter-flow method where fuel gas and oxidant gas flow in opposite directions.

Hereinafter, the upstream side in the flow direction of reactant gases through the gas passages 60 is simply referred to as the upstream side, and the downstream side in the flow direction is simply referred to as the downstream side.

Each gas passage 60 is formed into a substantially S-shape by connecting first extensions Lg1 to Lg3 to each other by second extensions Tg1 and Tg2. Reactant gas flows sequentially through the first extension Lg1, the second extension Tg1, the first extension Lg2, the second extension Tg2, and the first extension Lg3.

The first extensions Lg1 to Lg3 are arranged in parallel and spaced apart from each other in the Y-axis direction. The first extensions Lg1 to Lg3 extend in the X-axis direction while meandering in a wavy pattern.

The second extensions Tg1 and Tg2 extend straight, inclined relative to the hypothetical axis V, such that they are positioned progressively closer to one side in the X-axis direction as they extend downstream.

The upstream end of the first extension Lg1 is connected to the through-hole hs1 through the slits 42 of the frame 40. The second extension Tg1 connects the downstream end of the first extension Lg1 to the upstream end of the first extension Lg2. The second extension Tg2 connects the downstream end of the first extension Lg2 to the upstream end of the first extension Lg3. The downstream end of the first extension Lg3 is connected to the through-hole hs2 through the slits 42. When reactant gas flows from the first extension Lg1 to the first extension Lg2 through the second extension Tg1 and flows from the first extension Lg2 to the first extension Lg3 through the second extension Tg2, the flow direction of the reactant gas reverses. Thus, the second extensions Tg1 and Tg2 each define a fold-back portion of the gas passage 60.

### Partition Rib 70

A partition rib 70 is provided between two first extensions Lg1 and Lg2 in one of the gas passages 60 where the two first extensions Lg1 and Lg2 are closest to each other. The partition rib 70 partitions the two first extensions Lg1 and Lg2 from each other. A partition rib 70 is also provided between the two first extensions Lg2 and Lg3 in one of the gas passages 60 where the two first extensions Lg2 and Lg3 are closest to each other. The partition rib 70 partitions the two first extensions Lg2 and Lg3 from each other. The partition rib 70 extends along the two first extensions Lg2 and Lg3. The two partition ribs 70 have the same structures and features.

Hereinafter, the structure of the partition rib 70 that partitions the two first extensions Lg1 and Lg2 from each other will be described. Thus, the structure of the partition rib 70 that partitions the two first extensions Lg2 and Lg3 will not be described. The structure of the partition rib 70 of the anode separator 51 will be described. Thus, the structure of the partition rib 70 of the cathode separator 52 will not be described.

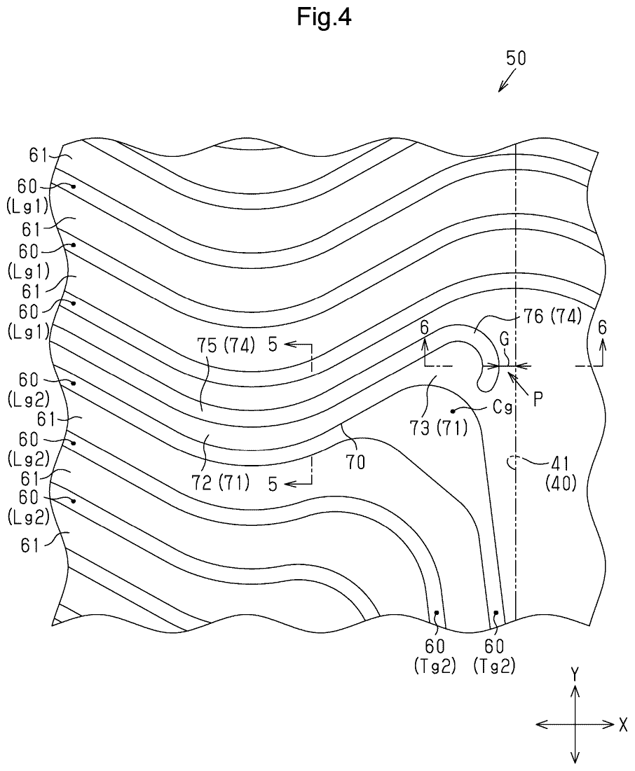

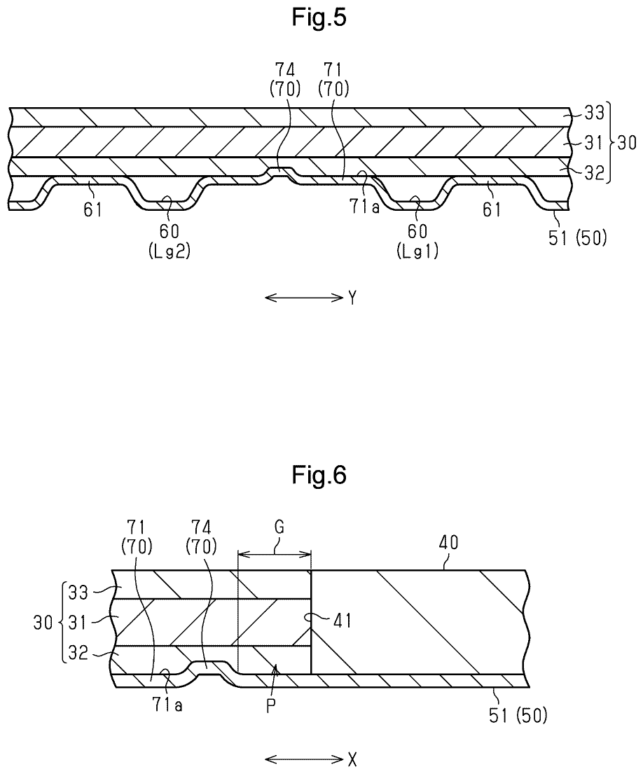

As shown in FIGS. 4 and 5, the partition rib 70 includes a base 71 that partitions the two first extensions Lg1 and Lg2 from each other, and a protrusion 74 that protrudes from the base 71 toward the anode-side gas diffusion layer 32. The base 71 and the protrusion 74 extend along the two first extensions Lg1 and Lg2.

As shown in FIG. 5, the base 71 includes a flat contact surface 71a that is in contact with the anode-side gas diffusion layer 32. The protrusion amount of the base 71 is the same as that of the rib 61.

The protrusion 74 extends from the contact surface 71a toward one side in the stacking direction. The protrusion 74 extends to a position where it faces the inner surface of the accommodating hole 41 of the frame 40. The protrusion 74 protrudes into the anode-side gas diffusion layer 32. The protrusion 74 has a flat top surface and two side surfaces that become farther from each other as they extend from the top surface toward the contact surface 71a. The width of the protrusion 74 and the protrusion amount from the contact surface 71a are constant over the entirety of the protrusion 74 in the longitudinal direction of the protrusion 74.

If the protrusion amount of the protrusion 74 is excessively large, the gas diffusion layer 32 may crack on the anode side. Accordingly, it is preferred that the protrusion amount of the protrusion 74 be approximately several percent of the protrusion amount of the base 71. The protrusion amount of the protrusion 74 in the present embodiment is set to approximately 7% of the protrusion amount of the base 71. In each figure, the protrusion amount of the protrusion 74 is exaggerated.

As shown in FIG. 4, the base 71 includes a first wavy portion 72 and a widened portion 73. The first wavy portion 72 is located between two first extensions Lg1 and Lg2 and extends in a wavy manner along the first extensions Lg1 and Lg2. The widened portion 73 is located between the first extension Lg1 and a curved portion Cg of the gas passage 60 that connects the first extension Lg2 to the second extension Tg2. The width of the first wavy portion 72 is greater than the width of each of the two ribs 61, which form the first extensions Lg1 and Lg2 together with the partition rib 70. The width of the widened portion 73 gradually increases as it extends farther away from the first wavy portion 72.

The protrusion 74 includes a second wavy portion 75 that protrudes from the first wavy portion 72 and an opposing end 76 that protrudes from the widened portion 73. The second wavy portion 75 extends in a wavy manner along the first extensions Lg1 and Lg2. The second wavy portion 75 extends over substantially the entire first wavy portion 72 in the longitudinal direction so as to pass through a widthwise middle portion of the first wavy portion 72. Of the two longitudinal ends of the protrusion 74, the opposing end 76 is located farther from the second extension Tg1. The opposing end 76 is opposed to the inner surface of the accommodating hole 41 in the X-axis direction. The opposing end 76 is curved from the second wavy portion 75 and extends in the Y-axis direction. Specifically, the opposing end 76 extends from the second wavy portion 75 toward the curved portion Cg. The opposing end 76 is curved so as to project toward the inner surface of the accommodating hole 41 as viewed in the stacking direction. An intermediate portion between the basal end and the distal end of the opposing end 76 is closer to the inner surface of the accommodating hole 41 in the X-axis direction than the basal end and the distal end are.

A pressure loss increasing portion P is provided at the boundary between the opposing end 76 and the inner surface of the accommodating hole 41. The pressure loss increasing portion P causes the pressure loss of reactant gas flowing between the two first extensions Lg1 and Lg2 beyond the opposing end 76 to be higher than the pressure loss of reactant gas flowing through the two first extensions Lg1 and Lg2. The pressure loss increasing portion P is defined by a gap G between the opposing end 76 and the inner surface of the accommodating hole 41. The gap G gradually increases from the basal end to the intermediate portion of the opposing end 76, and gradually decreases from the intermediate portion to the distal end.

The opposing end 76 may be in contact with the inner surface of the accommodating hole 41. However, if the opposing end 76 overlaps the frame 40 in the stacking direction, an unintended gap may form between the frame 40 and the separator 50, resulting in the leakage of reactant gas from the single cell 20 to the outside. Thus, to avoid the overlapping of the opposing end 76 with the frame 40 in the stacking direction, the present embodiment provides the gap G between the opposing end 76 and the inner surface of the accommodating hole 41 based on manufacturing tolerances of the fuel cell stack 10. The cross-sectional area of the gap G is smaller than the cross-sectional flow area of each of the first extensions Lg1 and Lg2. The cross-sectional area of the gap G changes depending on where it is located in the X-axis direction. In the present embodiment, the maximum value of the cross-sectional area of the gap G is smaller than the cross-sectional flow area of each of the first extensions Lg1 and Lg2.

### Cooling Passage 80

As shown in FIG. 1, in the fuel cell stack 10, the anode separator 51 of one of two single cells 20 adjacent to each other in the stacking direction is in contact with the cathode separator 52 of the other single cell 20. The cooling passages 80, through which cooling medium flows, are formed between the anode separator 51 and the cathode separator 52 that are in contact with each other in the two adjacent single cells 20 in the stacking direction. A gasket (not shown) is arranged between the anode separator 51 and the cathode separator 52, which are in contact with each other, to provide a seal between the two single cells 20.

As shown in FIG. 2, the separator 50 includes cooling grooves 81 that define the cooling passages 80. The cooling grooves 81 are located on the surface of the separator 50 that is opposite to the surface on which the gas passages 60 are formed. The cooling groove 81 is formed in conformance with the shape of the rear surface of the rib 61. The cooling groove 81 has a serpentine shape extending in a meandering pattern from the through-hole hs1 to the through-hole hs2.

The cooling passage 80 is formed by the gap between the cooling groove 81 of the anode separator 51 and the cooling groove 81 of the cathode separator 52. The cooling medium supplied from the cooling medium supply manifold M5 flows through the cooling passage 80 and is then discharged from the cooling medium discharge manifold M6.

### Operation of Present Embodiment

As shown in FIG. 5, since the protrusion 74 of the partition rib 70 protrudes into the anode-side gas diffusion layer 32, the anode-side gas diffusion layer 32 is compressed locally. The compressed section of the anode-side gas diffusion layer 32 limits the flow of reactant gas, thereby limiting the flow of reactant gas between the two first extensions Lg1 and Lg2 beyond the protrusion 74.

Further, as shown in FIG. 4, the pressure loss increasing portion P is provided at the boundary between the opposing end 76 of the protrusion 74 and the inner surface of the accommodating hole 41. The pressure loss increasing portion P causes the pressure loss of reactant gas flowing between the two first extensions Lg1 and Lg2 beyond the opposing end 76 to be higher than the pressure loss of reactant gas flowing through the two first extensions Lg1 and Lg2. Accordingly, the reactant gas flowing between the two first extensions Lg1 and Lg2 is less likely to flow between the first extensions Lg1 and Lg2 beyond the opposing end 76. Thus, the reactant gas flows more easily between the two first extensions Lg1 and Lg2 through the second extension Tg1.

### Advantages of Present Embodiment

(1) The separator 50 includes the partition rib 70. The partition rib 70 is located between the two first extensions Lg1 and Lg2, through which reactant gas flows in opposite directions. The partition rib 70 includes the protrusion 74, which protrudes into the anode-side gas diffusion layer 32. The protrusion 74 has the opposing end 76, which is opposed to the inner surface of the accommodating hole 41. The pressure loss increasing portion P is provided at the boundary between the opposing end 76 and the inner surface of the accommodating hole 41 of the frame 40.

This configuration produces the above-described operation. This limits path cut, in which reactant gas flows between the two first extensions Lg1 and Lg2 beyond the partition rib 70 within the anode-side gas diffusion layer 32. Thus, such a relatively simple arrangement of the protrusion 74 in the partition rib 70 limits path cut of the reactant gas.

(2) The pressure loss increasing portion P is defined by the gap G, which is between the opposing end 76 and the inner surface of the accommodating hole 41. The cross-sectional area of the gap G is smaller than the cross-sectional flow area of each of the first extensions Lg1 and Lg2.

In this configuration, such a relatively simple arrangement of the gap G between the opposing end 76 and the inner surface of the accommodating hole 41 achieves the pressure loss increasing portion P.

(3) The opposing end 76 extends in the arrangement direction of the two first extensions Lg1 and Lg2.

This configuration expands the range in which the gap G between the opposing end 76 and the inner surface of the accommodating hole 41 forms. Accordingly, the pressure loss of the reactant gas increases over a broader area. As a result, path cut of the reactant gas is further limited.

(4) The protrusion 74 has the width that is constant over the entirety of the protrusion 74 in the longitudinal direction.

The compressed section of the anode-side gas diffusion layer 32 provided by the protrusion 74 limits the flow of reactant gas. Thus, if the protrusion 74 includes sections that differ in width, the reactant gas reaching the power generating unit 30 may be insufficient at a relatively wide section. As a result, there is a risk that the power generation amount of the power generating unit 30 may decrease locally.

In the above-described configuration, the protrusion 74 has the width that is constant over the entirety of the protrusion 74 in the longitudinal direction. This limits situations in which the amount of power generated by the power generating unit 30 decreases locally.

(5) The base 71 and the protrusion 74 extend while meandering in a wavy manner along the first extensions Lg1 and Lg2.

For example, if the first extensions Lg1 and Lg2 extend while meandering in a wavy manner and the protrusion 74 extends linearly, the width of the base 71 extending while meandering in a wavy manner may increase. This widens the region in which the partition rib 70 is in contact with the anode-side gas diffusion layer 32. As a result, reactant gas is less likely to reach the portion of the power generating unit 30 that is in contact with the partition rib 70. This may locally decrease the amount of power generated by the power generating unit 30.

In the above-described configuration, the base 71 and the protrusion 74 extend while meandering in a wavy manner along the first extensions Lg1 and Lg2. Thus, as compared to when the protrusion 74 extends linearly, the increase in the width of the partition rib 70 is limited. This limits situations in which the amount of power generated by the power generating unit 30 decreases locally.

### Modifications

The present embodiment may be modified as follows. The present embodiment and the following modifications can be combined as long as they remain technically consistent with each other.

The first extensions Lg1 to Lg3 may extend while meandering in a wavy manner and the second wavy portion 75 of the protrusion 74 may extend linearly in the X-axis direction.

The first extensions Lg1 to Lg3 may extend linearly in the X-axis direction and the second wavy portion 75 of the protrusion 74 may extend in the X-axis direction while meandering in a wavy manner.

The first extensions Lg1 to Lg3 may extend linearly in the X-axis direction and the second wavy portion 75 of the protrusion 74 may extend linearly in the X-axis direction.

The width of the protrusion 74 does not have to be constant over the entirety of the protrusion 74. For example, the width of the opposing end 76 may be greater than the width of the second wavy portion 75.

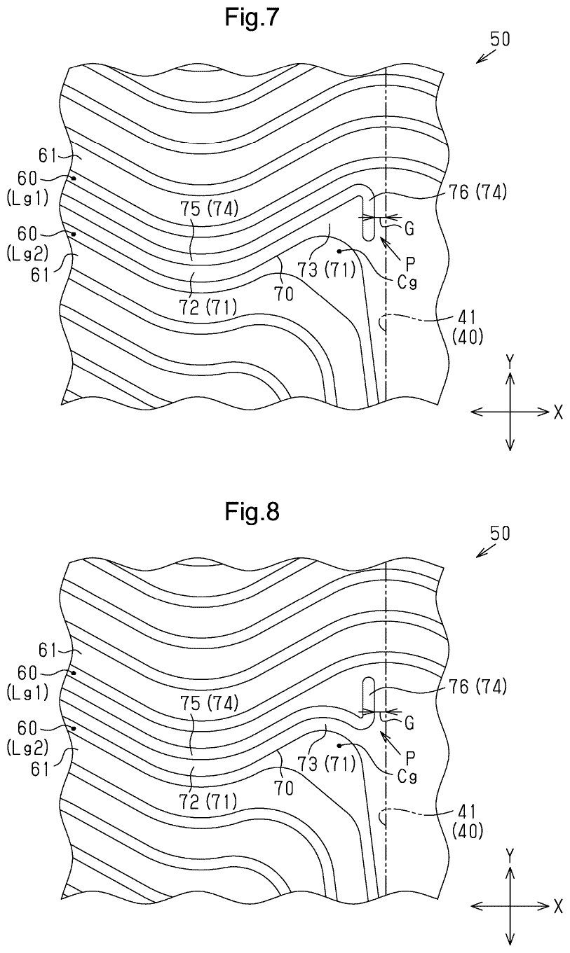

As shown in FIG. 7, the opposing end 76 may extend linearly in the Y-axis direction along the inner surface of the accommodating hole 41.

As shown in FIG. 8, the opposing end 76 may extend from the second wavy portion 75 toward a side farther from the curved portion Cg in the Y-axis direction.

The opposing end 76 does not have to extend in the arrangement direction of the first extensions Lg1 to Lg3. The opposing end 76 may extend in the X-axis direction.

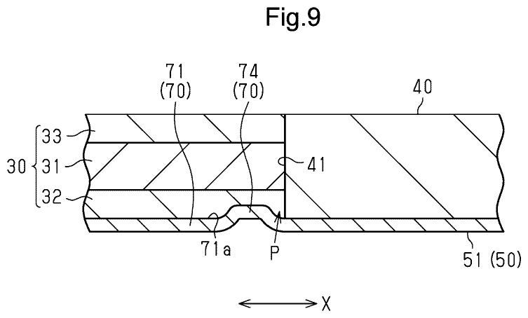

As shown in FIG. 9, the opposing end 76 may be in contact with the inner surface of the accommodating hole 41. Additionally, the side surface of the protrusion 74 may be oriented perpendicularly to the contact surface 71a. In this case, the side surface of the protrusion 74 makes surface contact with the inner surface of the accommodating hole 41. In this case, no gap G is created at the boundary between the opposing end 76 and the inner surface of the accommodating hole 41. Even in these configurations, the boundary area between the opposing end 76 and the inner surface of the accommodating hole 41 acts as the pressure loss increasing portion P. Therefore, the above-described advantage (1) is achieved.

Reactant gas in the fuel cell stack 10 may be supplied using, for example, a co-flow method where fuel gas and oxidant gas flow in the same direction in the first extensions Lg1, Lg2, and Lg3 of each separator 50.

Each slit 42 does not necessarily need to extend through the frame 40, and may be formed as a groove that opens on one side of the frame 40 in the thickness direction. In this case, the frame 40 may include the slits 42 between the accommodating hole 41 and the through-holes hf1 and hf2 on the surface of the frame 40 facing the anode separator 51. Alternatively, the frame 40 may include the slits 42 between the accommodating hole 41 and the through-holes hf3 and hf4 on the surface of the frame 40 facing the cathode separator 52.

The material of the separator 50 may be a carbon material or a composite material containing carbon and resin materials.

The separator 50 may be formed by machining or injection molding.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. A fuel cell stack, comprising stacked single cells, wherein
each of the single cells includes:
a power generating unit that includes a membrane electrode assembly and two gas diffusion layers, the gas diffusion layers sandwiching the membrane electrode assembly;
a frame including an accommodating hole that accommodates the power generating unit; and
two separators that sandwich the power generating unit and the frame,
each of the separators of the single cell has a surface facing the power generating unit, wherein the surface facing the power generating unit has a gas passage through which reactant gas flows,
the gas passage includes:
first extensions which are arranged in parallel to each other and in which the reactant gas flows in opposite directions; and
a second extension that connects ends of two of the first extensions arranged in parallel,
a partition rib is provided between the two of the first extensions connected to each other by the second extension, the partition rib partitioning the two of the first extensions from each other,
the partition rib includes:
a base that is in contact with a corresponding one of the two gas diffusion layers of the power generating unit and extends along the first extensions; and
a protrusion that protrudes from the base into the corresponding one of the two gas diffusion layers and extends along the first extensions,
the protrusion has an opposing end opposed to an inner surface of the accommodating hole, and
a pressure loss increasing portion is provided at a boundary between the opposing end and the inner surface of the accommodating hole, the pressure loss increasing portion causing a pressure loss of the reactant gas flowing between the two of the first extensions beyond the opposing end to be higher than a pressure loss of the reactant gas flowing through the two of the first extensions.

2. The fuel cell stack according to claim 1, wherein
the pressure loss increasing portion is defined by a gap between the opposing end and the inner surface of the accommodating hole, and
a cross-sectional area of the gap is smaller than a cross-sectional flow area of each of the two of the first extensions.

3. The fuel cell stack according to claim 1, wherein
the opposing end extends in an arrangement direction of the two of the first extensions.

4. The fuel cell stack according to claim 1, wherein
the protrusion has a width that is constant over the entirety of the protrusion in a longitudinal direction of the protrusion.

5. The fuel cell stack according to claim 1, wherein
the first extensions extend while meandering in a wavy manner, and
the base and the protrusion extend while meandering in a wavy manner along the first extensions.
